(19) United States
(12) Patent Application Publication
(10) Pub. No.: US 2023/0378544 A1
(43) Pub. Date: Nov. 23, 2023

(54) ALL-SOLID-STATE BATTERY

(71) Applicant: SAMSUNG ELECTRO-MECHANICS CO., LTD., Suwon-si, Gyeonggi-do (KR)

(72) Inventors: Kyong-Bok Min, Suwon-si, Gyeonggi-do (KR); Tae-Hoon Kim, Suwon-si, Gyeonggi-do (KR); Ji-Hyung Jung, Suwon-si, Gyeonggi-do (KR)

(73) Assignee: SAMSUNG ELECTRO-MECHANICS CO., LTD., Suwon-si, Gyeonggi-do (KR)

(21) Appl. No.: 18/027,694

(22) PCT Filed: Nov. 3, 2021
(86) PCT No.: PCT/KR2021/015781

§ 371 Date: Mar. 22, 2023

(30) Foreign Application Priority Data
Dec. 31, 2020 (KR) 10-2020-0189796

(51) Int. Cl. H01M 10/058; H01M 50/531; H01M 50/548; H01M 4/66; H01M 4/13; H01M 50/103; H01M 4/70

(52) U.S. Cl. CPC H01M 10/058; H01M 50/531; H01M 50/548; H01M 4/661; H01M 4/13; H01M 50/103; H01M 4/70

(57) ABSTRACT

An all-solid-state battery includes: a columnar battery cell, having a central axis extending in a first direction, in which a positive electrode active material, a positive electrode support, a solid electrolyte layer, a negative active material, and a negative electrode support are sequentially stacked from a center of the battery cell; a plurality of connection members disposed on both surfaces of the battery cell in a third direction; a negative electrode terminal connected to the connection members; and a positive electrode terminal connected to the connection members. The all-solid-state battery includes a groove portion disposed in the third direction of the battery cell and disposed in the first direction, and includes at least two battery cells.

### TECHNICAL FIELD

The present disclosure relates to an all-solid-state battery.

### BACKGROUND ART

Recently, devices using electricity as an energy source have been increasing. With the expansion of applications of devices using electricity as an energy source, such as smartphones, camcorders, laptop PCs, electric vehicles, and the like, interest in electric storage devices using electrochemical elements is increasing. Among various electrochemical elements, lithium secondary batteries that may be charged and discharged, have a high operating voltage, and a high energy density, have come into the spotlight.

A lithium secondary battery may be manufactured by applying a material capable of intercalating and de-intercalating lithium ions into a positive electrode and a negative electrode, and injecting a liquid electrolyte between the positive electrode and the negative electrode, and electricity may be generated or consumed by the reduction or oxidation reaction of the lithium secondary battery intercalating and de-intercalating the lithium ions within the negative electrode and the positive electrode. Such a lithium secondary battery should basically be stable in the operating voltage range of the battery, and should have performance capable of transferring ions at a sufficiently high rate.

When a liquid electrolyte, such as a nonaqueous electrolyte, is used in the lithium secondary battery, discharge capacity and energy density may be advantageously high. However, it may be difficult to implement high voltage lithium secondary batteries, and issues such as relatively high risk of electrolyte leakage, fires, and explosions may occur.

To address the above issues, a secondary battery using a solid electrolyte, rather than a liquid electrolyte, has been proposed as an alternative. The solid electrolyte may be classified as a polymer-based solid electrolyte or a ceramic-based solid electrolyte. The ceramic-based solid electrolyte is advantageous in exhibiting high stability. However, a battery using a ceramic-based solid electrolyte suffers from stress remaining therein due to a difference in sintering contraction during a sintering process, and repeatedly contracts and expands when repeatedly charged and discharged, so that mechanical strength of the battery itself may be reduced.

### DISCLOSURE OF INVENTION

### Technical Problem

An aspect of the present disclosure is to provide an all-solid-state battery having structural stability.

Another aspect of the present disclosure is to provide an all-solid-state battery for improving mechanical strength.

Another aspect of the present disclosure is to provide an all-solid-state battery having improved long-term reliability.

### Solution to Problem

According to an aspect of the present disclosure, an all-solid-state battery includes: a columnar battery cell, having a central axis extending in a first direction, in which a positive electrode active material, a positive electrode support, a solid electrolyte layer, a negative active material, and a negative electrode support are sequentially stacked from a center of the battery cell; a plurality of connection members disposed on both surfaces of the battery cell in a third direction; a negative electrode terminal connected to the connection members; and a positive electrode terminal connected to the connection members. The all-solid-state battery includes a groove portion disposed in the third direction of the battery cell and disposed in the first direction, and includes at least two battery cells.

### Advantageous Effects of Invention

As described above, structural stability of an all-solid-state battery may be improved.

In addition, mechanical strength of an all-solid-state battery may be improved.

In addition, an all-solid-state battery having improved long-term reliability may be provided.

### BRIEF DESCRIPTION OF DRAWINGS

The above and other aspects, features, and advantages of the present disclosure will be more clearly understood from the following detailed description, taken in conjunction with the accompanying drawings.

FIG. 1 is a schematic perspective view of an all-solid-state battery according to an exemplary embodiment of the present disclosure.

FIG. 2 is a schematic perspective view of a battery body of FIG. 1.

FIG. 3 is a perspective view of an exemplary structure of a battery cell according to the present disclosure.

FIGS. 4 and 5 are cross-sectional views of exemplary shapes of a battery cell according to the present disclosure, respectively.

FIGS. 6 and 7 are perspective views of modified shapes of an all-solid-state battery according to the present disclosure, respectively.

### MODE FOR THE INVENTION

Hereinafter, embodiments of the present disclosure will be described in detail with reference to the accompanying drawings. The present disclosure may, however, be exemplified in many different forms and should not be construed as being limited to the specific embodiments set forth herein. Further, embodiments of the present disclosure may be provided for a more complete description of the present disclosure to those skilled in the art. Accordingly, the shapes and sizes of the elements in the drawings may be exaggerated for clarity of description, and the elements denoted by the same reference numerals in the drawings may be the same elements.

In order to clearly illustrate the present disclosure, portions not related to the description are omitted, and thicknesses are enlarged in order to clearly represent layers and regions, and similar portions having the same functions within the same scope are denoted by similar reference numerals throughout the specification.

In the present specification, expressions such as “have.” “may have,” “include.” “comprise,” “may include,” or “may comprise” may refer to the presence of corresponding features (for example, elements such as numbers, functions, actions, or components), and does not exclude the presence of additional features.

In the present specification, expressions such as “A and/or B,” “at least one of A and B.” or “one or more of A and B” may include all possible combinations of items listed together. For example, “A and/or B,” “at least one of A and B,” or “one or more of A and B” may refer to (1) including at least one A, (2) including at least one B, or (3) including all at least one A and at least one B.

As used herein, the term “vertical.” “horizontal.” and/or “parallel” does not refer to 90° and/or 0° in a strict sense, but may refer to a value including an error. The error may refer to, for example, a range of ±5° or less.

In the drawings, an X direction may be defined as a first direction, an L direction, or a length direction, a Y direction may be defined as a second direction, a W direction, or a width direction, and a Z direction may be defined as a third direction, a T direction, or a thickness direction.

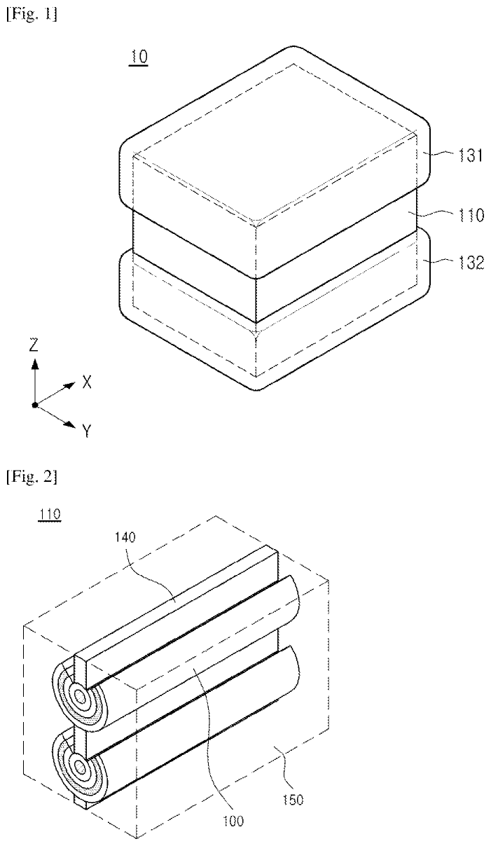

The present disclosure relates to an all-solid-state battery 100. FIGS. 1 to 5 are schematic views of an all-solid-state battery 10 according to an exemplary embodiment of the present disclosure. Referring to FIGS. 1 to 5, the all-solid-state battery 10 according to the present disclosure may include a battery body 110 including a columnar battery cell 100, in which a positive electrode active material 121, a positive electrode support 122, a solid electrolyte layer 111, a negative active material 123, and a negative electrode support 124 are sequentially stacked from a center of the battery cell 100, and a groove portion 125 and a plurality of connection members 140 disposed on the battery cell 100, and having a first surface and a second surface opposing each other in a first direction X parallel to a central axis of the battery cell 100, a third surface and a fourth surface opposing each other in a second direction Y, perpendicular to the first direction X, and a fifth surface and a sixth surface opposing each other in a third direction Z, perpendicular to the first direction X and the second direction Y; a positive electrode terminal 131 connected to the plurality of connection members 140 and disposed on the fifth surface of the battery body 110; and a negative electrode terminal 132 connected to the plurality of connection members 140 and disposed on the sixth surface of the battery body 110.

In this case, the battery cell may include a groove portion 125 disposed on one surface in the third direction Z, and the all-solid-state battery 10 according to the present disclosure may include two or more battery cells 100. The battery cell 100 may have a columnar shape having a central axis extending in the first direction X. As used herein, the term “columnar” may refer to a shape of an even polyhedron having dihedral symmetry, and may be a shape including both a prism and a cylinder. An allsolid-state battery according to the related art uses a structure in which plate-shaped electrodes are formed to face each other. However, in the case of a sintered battery, internal stress may occur due to a difference in contraction behavior during a sintering process. In addition, contraction and expansion of the sintered battery may be repeated due to high-temperature and low-temperature cycles based on charging and discharging during use of the battery after being manufactured, so that the battery may be continuously exposed to mechanical stress to cause cracking, or the like. Since the allsolid-state battery 10 according to the present disclosure includes a battery cell 100 having a columnar shape, internal stress and stress caused by expansion and contraction may be uniformly distributed to increase mechanical strength and to improve long-term reliability.

In the battery cell 100 of the all-solid-state battery 10 according to the present disclosure, a positive electrode active material 121, a positive electrode support 122, a solid electrolyte layer 111, a negative electrode active material 123, and a negative electrode support 124 may be sequentially stacked from a center of the battery cell 100.

Examples of the positive electrode active material 121 may be compounds represented by the following formulas: LiₐA_{1-b}M_{b}D₂ (where 0.90≤a≤1.8 and 0≤b≤0.5); Liₐ E_{1-b}M_{b}O₂D_{c} (where 0.90≤a≤1.8, 0≤b≤0.5, and 0≤c≤0.05); LiE_{2-b}M_{b}O_{4-c}D_{c} (where 0≤b≤0.5 and 0≤c≤0.05); LiaNi_{1-b-c}Co_{b}M_{c}D_{α} (where 0.90≤a≤1.8, 0≤b≤0.5, 0≤c≤0.05, and 0<α<2); LiₐNi_{1-b-c}Co_{b}M_{c}O_{2-α}X_{α} (where 0.90≤a≤1.8, 0≤b≤0.5, 0≤c≤0.05, and 0<α<2); LiₐNi_{1-b-c}Co_{b}M_{c}O_{2-α}X_{α} (where 0.90≤a≤1.8, 0≤b≤0.5, 0≤c0.05, and 0<α<2); LiₐNi_{1-b-c}Mn_{b}M_{c}D_{α} (where 0.90≤a≤1.8, 0≤b≤0.5, 0≤c≤0.05, and 0<α<2); LiₐNi_{1-b-c}Mn_{b} M_{c}O₂X_{α} (where 0.90≤a≤1.8, 0≤b≤0.5, 0≤c≤0.05, and 0<α<2); LiₐNi_{1-b-c}Mn_{b}M_{c}O_{2-α}X₂ (where 0.90≤a≤1.8, 0≤b≤0.5, 0≤c≤0.05, and 0<α<2); LiₐNi_{b}E_{c}G_{d}O₂ (where 0.90<a≤1.8, 0≤b≤0.9, 0≤c≤0.5, and 0.001≤d≤0.1); LiₐNi_{b}Co_{c}Mn_{d}GₑO₂ (where 0.90≤a≤1.8, 0≤b≤0.9, 0≤c≤0.5, 0≤d≤0.5, and 0.001≤e≤0.1). LiₐNiG_{b}O₂ (where 0.90≤a≤1.8 and 0.001≤b≤0.1); LiₐCoG_{b}O₂ (where 0.90≤a≤1.8 and 0.001≤b≤0.1); Liₐ MnG_{b}O₂ (where 0.90<a≤1.8 and 0.001≤b≤0.1); LiₐMn₂G_{b}O₄ (where 0.90≤a≤1.8 and 0.001≤b≤0.1); QO₂; QS₂; LiQS₂; V₂O₂; LiV₂O₂; LiRO₂; LiNiVO₄; Li_{(3-f)}J₂(PO₄)₃ (where 0≤f≤2); Li_{(3-f)}Fe₂(PO₄)₃ (where 0≤f≤2); and LiFePO₄, in which A is Ni, Co, or Mn; M is Al, Ni, Co, Mn, Cr, Fe, Mg, Sr, V, or a rare earth element; D is O, F, S, or P; E is Co or Mn; X is F, S, or P; G is Al, Cr, Mn, Fe, Mg, La, Ce, Sr, or V; Q is Ti, Mo, or Mn; R is Cr, V, Fe, Sc, or Y; and J is V, Cr, Mn, Co, Ni, or Cu.

The positive electrode active material 121 may also be LiCoO₂, LiMnₓO₂ₓ (where x=1 or 2), LiNi₁₋ₓMnO₂ₓ (where 0<x<1), LiNi_{1-x-y}CoₓMnₓO₂ (where 0≤x≤0.5 and 0≤y≤0.5), LiFePO₄, TiS₂, FeS₂, TiS₃, or FeS₃, but is not limited thereto.

The positive electrode active material 121 of the all-solid-state battery 10 according to the present disclosure may selectively include a conductive material and a binder. The conductive material is not limited as long as it has conductivity without causing a chemical change in the all-solid-state battery 100 according to the present disclosure. For example, the conductive material may be or include graphite such as natural graphite or artificial graphite; a carbon-based material such as carbon black, acetylene black, ketjen black, channel black, furnace black, lamp black, or thermal black; a conductive fiber such as a carbon fiber and a metal fiber, carbon fluoride; metal powder such as aluminum or nickel powder, a conductive whisker such as a zinc oxide or potassium titanate whisker; a conductive metal oxide such as a titanium oxide; or a polyphenylene derivative.

The binder may be used to improve a bonding strength between the active material and the conductive agent. Examples of the binder may include polyvinylidene fluoride, polyvinyl alcohol, carboxymethylcellulose (CMC), starch, hydroxypropylcellulose, regenerated cellulose, polyvinylpyrrolidone, polytetrafluoroethylene, polyethylene, polypropylene, ethylene-propylene-diene terpolymer (EPDM), sulfonated EPDM, styrene butadiene rubber, fluorine rubber, and various copolymers, but are not limited thereto.

The positive electrode support 122 may serve to support the positive active material 121 disposed in the center of the battery cell 100. As the positive electrode support 122, a porous body in a net-shaped type, a mesh type, or the like may be used, and a porous metal plate made of stainless steel, nickel, aluminum, or the like may be used, but example embodiments are not limited thereto. In addition, the positive electrode support 122 may be coated with an anti-oxidation metal or alloy film to prevent oxidation.

In an exemplary embodiment of the present disclosure, the solid electrolyte layer 111 according to the present disclosure may include at least one selected from the group consisting of a Garnet-type solid electrolyte, a Nasicon-type solid electrolyte, a LISICON-type solid electrolyte, a perovskite-type solid electrolyte, and a LiPON-type solid electrolyte.

The Garnet-type solid electrolyte may refer to lithium lanthanum zirconium oxide (LLZO) represented by LiₐLa_{b}Zr_{c}O₁₂ such as Li₇La₃Zr₂O₁₂, and the Nasicon-type solid electrolyte may refer to lithium aluminum titanium phosphate (LATP) represented by Li₁₊ₓAlₓTi₂₋ₓ(PO₄)₃ (where 0<x<1), which is a compound of Li₁₊ₓAlₓM₂₋ₓ(PO₄)₃ (LAMP) (where 0<x<2 and M is Zr, Ti, or Ge) with Ti introduced thereinto, lithium aluminum germanium phosphate (LAGP) represented by Li₁₊ₓAlₓGe₂₋ₓ(PO₄)₃ (where 0<x<1) such as Li₁₃Al_{0.3}Ti_{1.7} (PO₄)₃ with an excessive amount of lithium introduced thereinto, and/or lithium zirconium phosphate (LZP) represented by LiZr₂(PO₄)₃.

The LISICON-type solid electrolyte may be represented by xLi₃AO₄—(1−x)Li₄BO₄ (where A is P, As, V, or the like, and B is Si, Ge, Ti, or the like), and may refer to a solid solution oxide, including Li₄Zn(GeO₄)₄, Li₁₀GeP₂O₁₂ (LGPO), Li_{3.5}Si_{0.5}P_{0.5}O₄, Li_{10.42} Si(Ge)₁₀₅P_{1.5}Cl_{0.005}O_{11.92}, or the like, or a solid solution sulfide represented by Li₄₋ₓM_{1-y}M′_{y}′S₄ (where M is Si or Ge, and M′ is P, Al, Zn, or Ga), including Li₂S—P₂S₅, Li₂S—SiS₂, Li₂S—SiS₂—P₂S₅, Li₂S—GeS₂, or the like.

The perovskite-type solid electrolyte may refer to lithium lanthanum titanate oxide (LLTO) represented by Li₃ₓLa_{2/3-x□1/3-2x}TiO₃ (where 0<x<0.16, □ denotes a vacancy), such as Li_{1/8}La_{5/8} TiO₃, and the LiPON-type solid electrolyte may refer to a nitride like lithium phosphorous oxynitride such as Li_{2.8}PO_{3.3}N_{0.46}.

The negative electrode active material 123 included in the all-solid-state battery 10 according to the present disclosure may include a commonly used negative active material. The negative active material may be a carbon-based material, silicon, a silicon oxide, a silicon-based alloy, a silicon-carbon-based material composite, tin, a tin-based alloy, a tin-carbon composite, a metal oxide, or combinations thereof, and may include a lithium metal and/or a lithium metal alloy.

The lithium metal alloy may include lithium and metal/metalloid alloyable with lithium. Examples of the metal/metalloid alloyable lithium may be Si, Sn, Al, Ge, Pb, Bi, Sb, an Si—Y alloy (where Y is an alkali metal, an alkali earth metal, a Group 13 to 16 element, a transition metal, a rare earth element, or combinations thereof, and does not include Si), an Sn—Y alloy (where Y is an alkali metal, an alkali earth metal, a Group 13 to 16 element, a transition metal, a transition metal oxide such as a lithium titanium oxide (Li₄Ti₅O₁₂), a rare earth element, or a combination thereof, and does not include Sn), and MnO, (where 0<x<2). The element Y may be Mg, Ca, Sr. Ba, Ra, Sc, Y, Ti, Zr, Hf. Rf, V, Nb, Ta, Db, Cr, Mo, W, Sg, Tc. Re, Bh, Fe, Pb, Ru, Os, Hs, Rh, Ir, Pd, Pt, Cu, Ag, Au, Zn, Cd, B, Al, Ga, Sn, In, Tl, Ge, P. As. Sb, Bi, S, Se. Te, Po, or combinations thereof.

In addition, the metal/metalloid oxide alloyable with lithium may be a lithium titanium oxide, a vanadium oxide, a lithium vanadium oxide, SnO₂, SiOₓ (where 0<x<2), or the like. For example, the positive electrode active material may include one or more elements selected from the group consisting of Group 13 to 16 elements of the periodic table of elements. Examples of the positive electrode active material may include one or more elements selected from the group consisting of Si, Ge, and Sn.

The carbon-based material may be crystalline carbon, amorphous carbon, or a mixture thereof. The crystalline carbon may be graphite such as natural graphite or artificial graphite in a shapeless, plate-like, flake, spherical, or fibrous form. In addition, the amorphous carbon may be soft carbon (low-temperature fired carbon), hard carbon, mesophase pitch carbide, fired cokes, graphene, carbon black, fullerene soot, carbon nanotubes, or carbon fibers, but examples of the carbon-based material are not limited thereto.

The silicon may be selected from the group consisting of Si, SiOₓ (where 0<x<2, for example 0.5 to 1.5), Sn, SnO₂, a silicon-containing metal alloy, and a mixture thereof. Examples of the silicon-containing metal alloy may include one or more of Al, Sn, Ag, Fe, Bi, Mg, Zn, In, Ge, Pb, and Ti, together with silicon.

The negative electrode support 124 may serve to support the negative electrode active material 123 disposed inside the battery cell 100. The negative electrode support 124 may be, for example, a porous body in a net-shaped type, a mesh type, or the like, and may be a porous metal plate formed of stainless steel, nickel, aluminum, or the like, but exemplary embodiments are not limited thereto. In addition, the negative electrode support 124 may be coated with an anti-oxidation metal or alloy film to prevent oxidation.

The battery cell 100 of the all-solid-state battery 10 according to the present disclosure may include a groove portion 125 disposed on one surface in the third direction. Referring to FIGS. 1 to 4, the groove portion 125 may refer to a region in which the solid electrolyte layer 111, the negative electrode active material 123, and the negative electrode support 124 are not disposed, and may refer to a region in which the positive electrode support 122 is exposed without being covered with the solid electrolyte layer 111, the negative electrode active material 123, and the negative electrode support 124. For example, the positive electrode support 122 of the battery cell 100 may be disposed on a bottom surface of the groove portion 125. The groove portion 125 may be disposed on the battery cell 100 to be parallel to the first direction X. The groove portion 125 may be a region for connection to a positive terminal 131 to be described later.

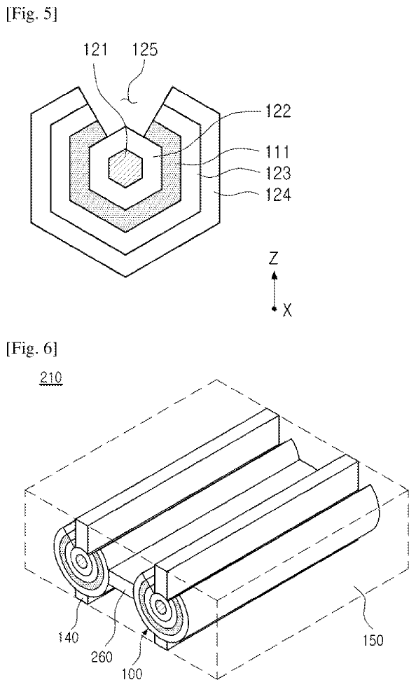

The battery cell 100 of the all-solid-state battery 10 according to an exemplary embodiment may have a columnar shape having a central axis parallel to the first direction X. The columnar shape may include both a cylinder and a prism. In the strict sense, the columnar shape may include not only a circle or a polygon but also the case, in which pressing occurs in a manufacturing process, and may include a cylindrical shape or a prismatic shape visible to the naked eye. FIGS. 4 and 5 schematically illustrate a cross-section of a cylindrical battery cell and a cross-section of a polygonal battery cell, respectively. In the drawing, the polygonal shape is a hexagonal shape, but may be various polygonal shapes such as a dodecagonal shape and an icositetragonal shape.

The battery cell 100 of the all-solid-state battery 10 according to the present disclosure may include a connection member 140 disposed in the third direction Z. The connection member 140 may be disposed on at least one surface of the battery cell 100 in the third direction Z. The connection member 140 may be disposed between one battery cell 100 and another battery cell 100 according to the present disclosure, between a battery cell 100 and a negative electrode terminal 132, and/or between a battery cell 100 and a positive electrode terminal 131 to make connections of the battery cell 100, the negative electrode terminal 132, and the positive electrode terminal 131.

In an example of the present disclosure, among connection members 140 of the allsolid-state battery according to the present disclosure, at least one connection member may be disposed in a groove portion 125. The clause “a connection member is disposed within a groove portion” may mean that the connection member is disposed in the groove portion to be connected to a positive electrode support of a battery cell. For example, the connection member 140 disposed in the groove portion 125 disposed in the third direction Z of the battery cell 100 may be disposed in the third direction Z of the battery cell 100. A connection member 140, connected to the positive electrode support 122, may serve as a positive electrode lead of the battery cell 100.

In addition, at least one of the connection members 140 disposed in the groove portion 125 may be connected to the positive electrode terminal 131. A connection member 140 disposed in the groove portion 125 may function as a positive lead, as described above. Among the connection members 140 disposed in the groove portion 125, a connection member 140 disposed to be closest to the positive electrode terminal 131 may be connected to the positive electrode terminal 131.

In another example of the present disclosure, at least one of the connection members 140 of the all-solid-state battery 10 according to the present disclosure may be disposed on the negative electrode support 124. The connection member 140, disposed on the negative electrode support 124, may be disposed in a direction opposing a third direction Z of the connection member 140 disposed in the above-mentioned groove portion 125. The connection member 140 disposed on the negative electrode support 124 may serve to connect negative electrodes to each other and may function as a negative electrode lead.

In addition, at least one of the connection members 140 disposed on the negative electrode support 124 may be connected to the negative electrode terminal 132. The connection member 140 disposed on the negative electrode support 124 may function as a negative lead, as described above. Among the connection members 140 disposed on the negative electrode support 124, a connection member 140 disposed to be closest to the negative terminal 132 may be connected to the negative electrode terminal 132.

As an example, among the connection members 140 of one battery cell 100 of the all-solid-state battery 10 according to the present disclosure, at least one connection member 140 may be disposed in the groove portion 125 and may be connected to the positive electrode support 122, and at least one connection member 140 may be disposed on the negative electrode support 124 of another battery cell 100. The connection member 140 disposed on the negative electrode support 124 may be disposed on a side opposing the third direction Z of the battery cell 100 in which the connection member 140 disposed in the groove portion 125 is disposed. For example, the all-solid-state battery according to the present example may include connection members 140, respectively disposed on both surfaces of the battery cell 100 in the third direction Z.

A material for forming the connection members 140 is not limited, and the connection members 140 may be formed using a conductive paste including one or more conductive metals of silver (Ag), palladium (Pd), gold (Au), platinum (Pt), nickel (Ni), copper (Cu), tin (Sn), tungsten (W), titanium (Ti), and alloys thereof.

The all-solid-state battery 10 according to the present disclosure may include two or more battery cells 100.

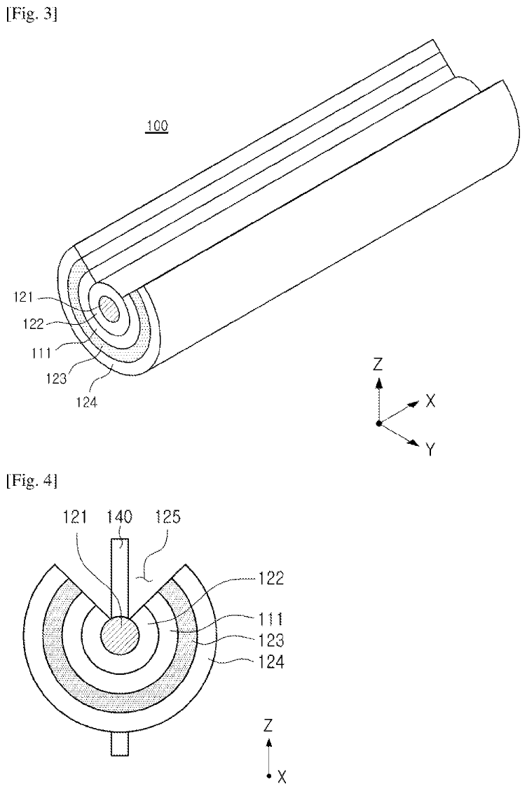

In an example of the present disclosure, two or more battery cells 100 may be stacked to be disposed in the third direction Z. FIG. 2 is a schematic perspective view of an all-solid-state battery according to the present example. Referring to FIG. 2, as described above, in the battery cell 100 of the all-solid-state battery 10 according to the present disclosure, a groove portion 125 may be disposed on one surface of the battery cell 100 in a third direction Z, one connection member 140 may be disposed in the groove portion 125, and another connection member 140 may be disposed on the other surface of the battery cell 100. In this case, the connection member 140 disposed in the groove portion 125 may function as a positive electrode lead, and the connection member 140 disposed on the negative electrode supporter 124 may function as a negative electrode lead. Accordingly, when the two or more battery cells 100 are stacked in the third direction Z, they may be two or more battery cells connected in series.

As used herein, the term “series” may refer to a state in which terminals having opposite polarities are connected to each other, and may refer to a state in which terminals having opposite polarities are connected such that the same current flows. In addition, the term “parallel” may refer to a state in which terminals having the same polarity are connected, and may refer to a state in which the terminals having the same polarity are not connected in series. In the all-solid-state battery according to the present disclosure, the battery cells may be connected in series only by being stacked in the third direction. Therefore, batteries of various voltages may be provided, as necessary.

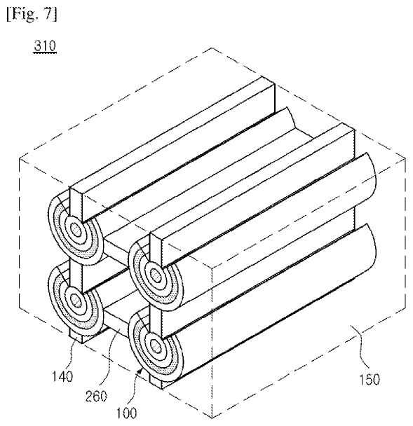

In another example of the present disclosure, in the all-solid-state battery according to the present disclosure, a plurality of battery cells may be disposed to be spaced apart from each other in the second direction. FIG. 6 is a schematic perspective view of an all-solid-state battery according to the present example. Referring to FIG. 6, the allsolid-state battery according to the present disclosure may include two or more battery cells 100 having a central axis parallel to a first direction, and the two or more battery cells 100 may be spaced apart from each other in a second direction. As in the present example, the all-solid-state battery 210 according to the present disclosure may form an all-solid-state battery, in which a plurality of battery cells 100 are connected in parallel, by disposing battery cells 100 in the second direction and connecting the battery cells together to a negative electrode terminal and a positive electrode terminal.

In this case, an insulating member may be disposed between the two or more battery cells disposed to be spaced apart from each other. The insulating member may include the same ceramic material as a battery molding portion to be described later, or may include a polymer such as an epoxy resin, but exemplary embodiments are not limited thereto.

In another example of the present disclosure, in the all-solid-state battery according to the present disclosure, two or more battery cells may be stacked in a third direction and, at the same time, two or more battery cells may be spaced apart from each other in a second direction, perpendicular to a first direction and a third direction. FIG. 7 is a schematic perspective view of an all-solid-state battery according to the present example. Referring to FIG. 7, the all-solid-state battery 310 according to the present example may include a plurality of battery cells 100, and the plurality of battery cells 100 may be disposed to be connected in series and in parallel. As described above, the all-solid-state battery 310 according to the present disclosure may include battery cells 100 stacked in a third direction to be connected in series. The battery cells 100 connected in series may be disposed in a second direction and may be connected to share a positive electrode terminal and a negative electrode terminal, disposed outside the battery cells, to be connected in parallel. Thus, the all-solid-state battery 310 according to the present disclosure may include a plurality of battery cells 100 which may be connected in series and/or in parallel as in the above example, and thus, may be modified according to various uses to further increase the utilization thereof.

As an example, the all-solid-state battery according to the present disclosure may further include a molding portion 150 disposed to surround a battery cell 100. The molding portion 150 may include a ceramic material, for example, alumina (Al₂O₃), aluminum nitride (AlN), beryllium oxide (BeO), boron nitride (BN), silicon (Si), silicon carbide (SiC), silica (SiO₂), silicon nitride (Si₃N₄), gallium arsenide (GaAs), gallium nitride (GaN), barium titanate (BaTiO₃), zirconium dioxide (ZrO₂), a mixture thereof, an oxide thereof, and/or a nitride thereof, or any other appropriate ceramic material, but is not limited thereto. In addition, the molding portion 150 may selectively use the above-described solid electrolyte, and may include at least one of the above-described solid electrolytes, but exemplary embodiments are not limited thereto. The molding portion may basically serve to prevent permeation of external moisture and the like, and to prevent external physical and chemical impacts.

As another example, the molding portion 150 of the all-solid-state battery according to the present disclosure may include a resin component. The resin component may be, for example, a thermosetting resin. The thermosetting resin may refer to a resin which may be cured by applying appropriate heat or by an aging process. Specific examples of heat cured resin include phenolic resins, urea resins, diallyl phthalate resins, melanin resins, guanamine resins, unsaturated polyester resins, polyurethane resins, epoxy resins, aminoalkyd resins, melamine-urea cocondensed resins, silicone resins, and polysiloxane resins. When the heat cured resin is used, as necessary, curing agents such as crosslinking agents and polymerization initiators, polymerization accelerators, solvents, and viscosity modifiers may be further added. The molding portion may be formed by transfer-molding a resin such as an epoxy molding compound (EMC) to surround a plurality of battery cells, but exemplary embodiments are not limited thereto.

The positive electrode terminal 131 and the negative electrode terminal 132 may be formed by applying, for example, a terminal electrode paste including a conductive metal, or applying a terminal electrode paste or powder to a connection member, led out to both surfaces of the molding portion in the third direction, and then sintering the paste or powder in an induction heating manner. The conductive metal may be at least one of, for example, copper (Cu), nickel (Ni), tin (Sn), palladium (Pd), platinum (Pt), gold (Au), silver (Ag), tungsten (W), titanium (Ti), lead (Pb), and alloys thereof, but examples of the conductive metal are not limited thereto.

In an example, the all-solid-state battery according to the present disclosure may further include plating layers (not illustrated), respectively disposed on the positive electrode terminal 131 and the negative electrode terminal 132. The plating layer may include at least one selected from the group consisting of copper (Cu), nickel (Ni), tin (Sn), palladium (Pd), platinum (Pt), gold (Au), silver (Ag), tungsten (W), titanium (Ti), lead (Pb), and alloys thereof, but exemplary embodiments are not limited thereto. The plating layer may be formed as a single layer or a plurality of layers, and may be formed by sputtering or electric deposition, but exemplary embodiments are not limited thereto.

Although the embodiments of the present disclosure have been described in detail above, the scope of the present disclosure is not limited thereto, and various modifications and variations are possible without departing from the technical spirit of the present disclosure described in the claims, which will be obvious to those of ordinary skill in the art.

While exemplary embodiments have been shown and described above, it will be apparent to those skilled in the art that modifications and variations could be made without departing from the scope of the present disclosure as defined by the appended claims.

1. An all-solid-state battery comprising:
a battery body including a plurality of columnar battery cells, each battery cell including a positive electrode active material, a positive electrode support, a solid electrolyte layer, a negative active material, and a negative electrode support are sequentially stacked from a center of the battery cell, and a groove portion and a plurality of connection members disposed on the battery cell, the battery body having a first surface and a second surface opposing each other in a first direction parallel to a central axis of the battery cell, a third surface and a fourth surface opposing each other in a second direction, different the first direction, and a fifth surface and a sixth surface opposing each other in a third direction, different from the first direction and the second direction;
a positive electrode terminal connected to one or more of the plurality of connection members and disposed on the fifth surface of the battery body; and
a negative electrode terminal connected to another one or more of the plurality of connection members and disposed on the sixth surface of the battery body,
wherein the groove portion is disposed on one surface of the battery cell in the third direction.

2. The all-solid-state battery of claim 1, wherein the positive electrode support and the negative electrode support includes a conductive metal.

3. The all-solid-state battery of claim 1, wherein the positive electrode support of the battery cell is disposed on a bottom surface of the groove portion.

4. The all-solid-state battery of claim 1, wherein at least one of the connection members is disposed in the groove portion and is connected to the positive electrode support.

5. The all-solid-state battery of claim 4 wherein at least one of the connection members, disposed in the groove portion, is connected to the positive electrode terminal.

6. The all-solid-state battery of claim 1, wherein at least another of the connection members is disposed on the negative electrode support.

7. The all-solid-state battery of claim 6, wherein at least one of the connection members, disposed on the negative electrode support, is connected to the negative electrode terminal.

8. The all-solid-state battery of claim 4, wherein at least one of the connection members is disposed on the negative electrode support, and the connection member, disposed on the negative electrode support, is disposed on a side opposing the third direction of the battery cell in which the connection member, disposed in the groove portion, is disposed.

9. The all-solid-state battery of claim 8, wherein two or more of the plurality of battery cells are disposed to be stacked in the third direction.

10. The all-solid-state battery of claim 8, wherein two or more of the plurality of battery cells are disposed to be spaced apart from each other in the second direction.

11. The all-solid-state battery of claim 10, further comprising:
an insulating member disposed between the two or more battery cells.

12. The all-solid-state battery of claim 1, wherein two or more of the plurality of battery cells are disposed to be stacked in the third direction, and
two or more of the plurality of battery cells are disposed to be spaced apart from each other in the second direction.

13. The all-solid-state battery of claim 12, further comprising:
a molding portion disposed to surround the battery cell.

14. The all-solid-state battery of claim 10, further comprising:
a molding portion disposed to surround the battery cell.

15. The all-solid-state battery of claim 1, further comprising:
a molding portion disposed to surround the battery cell.
